(19) United States
(12) Patent Application Publication
(10) Pub. No.: US 2012/0210686 A1
(43) Pub. Date: Aug. 23, 2012

(54) SAFETY ARRANGEMENT

(75) Inventor: Klaus Bihlet, Rander NO (DK)

(73) Assignee: NEDERMAN MANUFACTURING DENMARK A/S

(21) Appl. No.: 13/402,323

(22) Filed: Feb. 22, 2012

(30) Foreign Application Priority Data
Feb. 23, 2011 (DE) 20 2011 003 087.3

(51) Int. Cl. F16K 15/00; B01D 35/147

(52) U.S. Cl. 55/420; 137/515

(57) ABSTRACT

Described are embodiments of a safety arrangement for a fluid piping system with a check flap associated with the piping system, where said check flap enables a medium to flow in the piping in an unblocked direction from an area onto which flow occurs into an area off of which flow occurs and where in a blocking position said check flap counteracts flow in a blocked direction opposite to the unblocked direction by abutting a sealing face of the piping system, characterized in that in the rest position of the sealing face when there is no flow in the piping system the check flap is at a distance from the sealing face and starting from the rest position only comes to abut the sealing face on the application of pressure in the blocked direction.

### Cross Reference to Related Applications

The present application claims international priority under 35 U.S.C. §119 to co-pending German Patent Application No. 20 2011 003 087.3 filed Feb. 23, 2011, entitled “Sicherungsanordnung,” the entire content and disclosure of which is hereby incorporated by reference in its entirety.

### TECHNICAL FIELD

The invention concerns a safety arrangement for a fluid piping system with a check flap associated with the piping system, where said check flap enables a medium to flow in the piping in an unblocked direction from an area onto which flow occurs into an area off of which flow occurs and where in a blocking position said check flap counteracts flow in a blocked direction opposite to the unblocked direction by abutting a sealing face of the piping system.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation of the accompanying drawings.

FIG. 1 shows a partially cut-away perspective representation of a safety arrangement according to the invention,

FIG. 2 shows a side view of the safety arrangement according to FIG. 1 in the rest position,

FIG. 3 shows a side view of the safety arrangement according to FIG. 1 in the blocking position, and

FIG. 4 shows a side view of the safety arrangement according to FIG. 1 in a release position permitting flow in the unblocked direction.

### DETAILED DESCRIPTION OF EMBODIMENTS

Safety arrangements of this type are needed, e.g., in filter devices for dust-laden gases, in which in the course of gas purification it must be prevented that the dust-laden gas flows back from the area off of which flow occurs into the area onto which flow occurs.

Safety arrangements of this type are needed, e.g., in filter devices for dust-laden gases, in which in the course of gas purification it must be prevented that the dust-laden gas flows back from the area off of which flow occurs into the area onto which flow occurs.

In traditional check flaps there is in several cases an undesirable backflow of the fluid from the area off of which flow occurs into the area onto which flow occurs if there is an explosive increase in pressure.

To solve this problem a safety arrangement of the type described in the introduction is proposed in DE 20 2009 011 668.9, in which safety arrangement an arresting device is associated with the check flap, with which arresting device the check flap is arrested in a blocking position on overshooting a blocking force acting thereon in the blocking direction in which it also blocks flow through the piping in the unblocked direction.

The disclosed content of said publication is herewith incorporated in this description by express reference with regard to the construction and function of the arresting device.

However, in the operation of the safety arrangements described in said publication it has been shown that in flow-free operation with an explosive increase in pressure there can be an undesirable backflow of fluids from the piping system's area off of which flow occurs.

In view of these problems in the prior art it is the object of the invention to provide a safety arrangement which even in flow-free operation can reliably prevent a fluid pressure flow in case of an explosive increase in pressure in a piping system's area off of which flow occurs.

According to the invention this object is achieved by an extension of the known safety arrangements which is characterized essentially in that the check flap in the rest position without flow in the piping system is at a distance from the sealing face and starting from the rest position only comes to abut the sealing face under the influence of a flow in the blocked direction.

This invention goes back to the realization that the problems occurring in the prior art are primarily to be traced back to the fact that even an explosive increase in pressure in a piping system's area off of which flow occurs is not sufficient to overcome an arresting device's blocking force required to reach the blocking position since in the flow-free state the check flap already abuts the sealing face so that the check flap is not accelerated in the direction towards the blocking position in a manner favoring overcoming of the blocking force.

In safety arrangements according to the invention the check flap can be moved in the rest position. It does not abut the sealing face. Only through an increase in pressure in the area off of which flow occurs is it accelerated in the direction towards the sealing face. By this acceleration effect the overcoming of the blocking force is promoted so that the arresting position can be reached reliably. In connection with this it is recognized in the scope of the invention that it has no effect on the operational safety of piping systems if the safety arrangement in the rest position does not effect a tight closure in the area of the sealing face because in the rest position there is no fluid flow in the piping system in any case.

Just as in the safety arrangements known from DE 20 2009 011 668.9 the check flap of safety arrangements according to the invention can be pivoted about a pivot axle which is fixed relative to the piping system and which is preferably disposed above a safety area of the piping system, in particular running in the horizontal direction, and starting from the pivot axle can extend downwards approximately in a vertical plane, at least in the rest position.

During the normal operation of the fluid piping system the check flap is pivoted from the vertical plane in the direction towards the safety arrangement's area off of which flow occurs and thus allows the fluid flow to pass without noteworthy resistance. In the case of a flow in the blocked direction it arrives at the sealing face. In connection with this the sealing face can be formed, just as in the known piping arrangements, by an end face of a piping element, such as, for example, a pipe or tube of the piping system. The preferably rigid check flap is in this case expediently shaped to be approximately complementary to the end face forming the sealing face, where in the blocking position the end face is preferably covered completely by the check flap and in the rest position the check flap is disposed at a distance from the sealing face, where it expediently comes to abut the sealing face by pivoting about the pivot axle.

From the point of view of design it has been proven particularly simple if the sealing face is disposed completely in a plane making an acute angle of preferably approximately 3 to 30° with a vertical plane. A plane arrangement of the sealing can be achieved by simple cutting of pipes or tubes. With this plane curve of the sealing face the check flap can also have a plane curve. By positioning the sealing face at an angle of 3 to 30° relative to a vertical plane an appropriate acceleration of the check flap from the rest position in the direction towards the abutting face is enabled if there is a pressure increase in the piping system's area off of which flow occurs, whereby the overcoming of a blocking force of an arresting system is promoted. For this the safety arrangement according to the invention expediently comprises an arresting device associated with the check flap, with which arresting device it can be arrested in the blocking position after overcoming a predetermined blocking force so that the flow in the piping is also blocked in the unblocked direction.

Just like the arresting device described in DE 20 2009 011 668.9 the arresting device can preferably comprise an arresting arm, said arresting arm extending outside of the safety area transversely, in particular approximately perpendicularly, to the pivot axle, said arresting arm together with the check flap being pivotable relative to the pivot axle, said arresting arm in an arresting position working together with an arresting element which is fixed relative to the piping, and said arresting arm preferably being rod-shaped, where during a pivoting movement in the direction towards the arresting position said arresting arm is preloaded against a preload force acting approximately parallel to the pivot axle, where the arresting element has a preload face along which, during the pivoting movement, the arresting arm in sliding abutment slides in the direction towards the arresting position and, against a preload force counteracting its elastic deformation, is deflected in a direction running approximately parallel to the pivot axle. After passing the preload force in the course of the pivoting movement the arresting arm can reach a guide area, in particular a guide face, of the arresting element, along which the arresting arm is guided to the arresting position under the action of the preload force taken up in the preload area, where it has been proven particularly expedient if an extension of the preload face is disposed in the direction towards the guide face on a side of a normal to the guide surface at the point of intersection of the extension of the preload face with the guide face, specifically that side facing way from the arresting position.

Additional details relating to the structural arrangement of the arresting element and the arresting arm are described in DE 20 2009 011 668.9, to which reference is made.

If the safety area of the piping system is bounded by a housing, the arresting element can be fastened on an outer bounding face of the housing. A filter arrangement according to the invention with a safety arrangement according to the invention expediently comprises a piping system which comprises a pipe disposed in a housing, where a check flap is associated with said pipe, where an arresting arm rotationally fixedly connected to the check flap can be disposed outside of the housing.

In the following the invention is explained with reference to the drawings, to which reference is expressly made with regard to all details significant for the invention and not described in more detail in the description. In the drawings

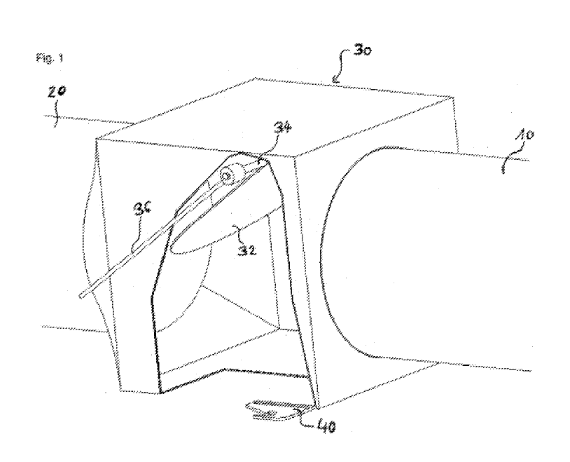

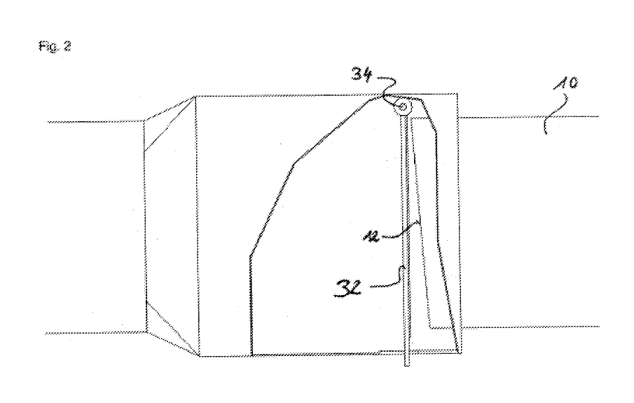

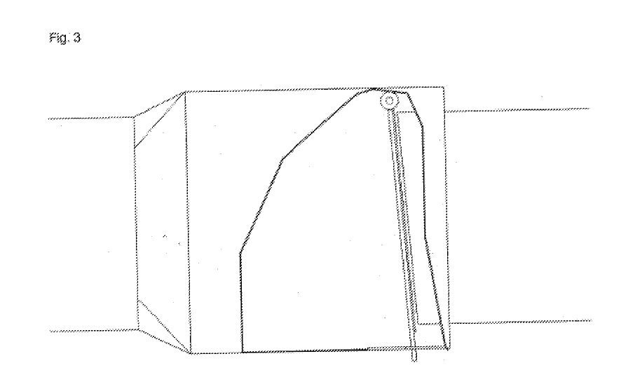

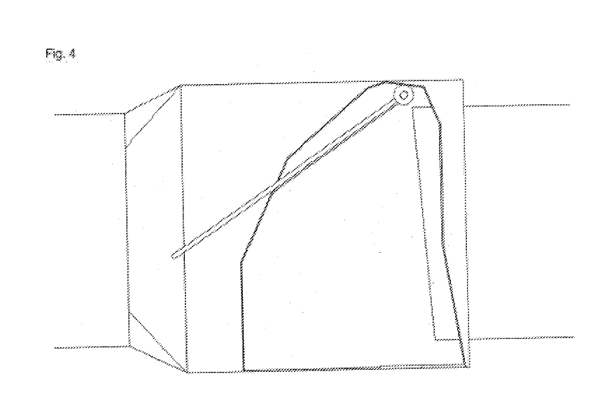

In FIG. 1 there are represented two pipes 10, 20 of a piping system which empty into a housing 30 bounding a safety area. In the safety area 30 the mutually facing end faces of the pipes 10, 20 are disposed at a distance from one another such that a check flap 32 can be pivoted between the tube ends. The check flap 32 is mounted in the housing 30 in such a manner that it can be pivoted relative to a pivot axle 34. Said check flap extends, starting from the pivot axle 34 in the flow-free rest position, downwards in a vertical plane, as can be seen particularly clearly in FIG. 2, and can under the influence of a flow in a desired direction of flow be pivoted from this rest position into the release position represented in FIG. 1 and FIG. 4. On the appearance of a counterpressure in the blocked direction opposite to the unblocked direction and from the area off of which flow occurs determined by the pipe 20 in the direction towards the area onto which flow occurs determined by the pipe 10 the check flap 32 is urged into the blocking position which can be seen in FIG. 3 and arrested there. For this an arresting arm 36 outside of the housing 30 is provided, said arresting arm being rotationally fixedly connected to the check flap 32 and being pivoted together with it about the pivot axle 34 as soon as an increase in pressure causes a pivoting of the check flap 32. In the arresting position the arresting arm 36 acts together with an arresting element 40 which is fastened on the outer bounding surface of the housing 30. The design of the arresting arm 36 and arresting element 40 is explained in detail in DE 20 2009 011 668.9, to which reference is made.

As can be seen particularly clearly in FIG. 2, the end face 12 of the pipe 10 is in a plane making an acute angle with a vertical plane, where this acute angle is approximately 10°. Thereby it is achieved that the check flap 32 hanging perpendicularly downwards is disposed in the rest position represented in FIG. 2 at a distance from the end face 12 and is only accelerated in the direction towards the end face 12 by a pressure increase in the area off of which flow occurs formed by the pipe 20, where the end face 12 forms a sealing face for the check flap 32 so that in the blocking position represented in FIG. 3, in which blocking position the check flap 32 abuts the end face 12 of the pipe 10 and said end face forms the sealing face, flow, from the area off of which flow occurs and which is formed by the pipe 20, in the direction towards the area onto which flow occurs is no longer possible.

In the blocking position according to FIG. 3 the arresting lever 36 rotationally fixedly connected to the check flap 32 is received in the arresting element 40 in such a manner that flow is also blocked in the unblocked direction.

The invention is not restricted to the embodiment example described using the drawings. Rather, use of safety arrangements with arched check flaps is also imagined if the end face of the pipe is shaped in an appropriately complementary manner for this purpose.

Also, safety arrangements according to the invention are also imagined in which the check flap is accommodated within the pipe cross sections so that the provision of a separate housing can be omitted.

It is significant in the scope of the invention that the check flap in the flow-free rest position is at a distance from the sealing face so that this high pressurization in both the blocked and unblocked directions can experience an accelerated movement under the action of pressure.

### LIST OF REFERENCE NUMBERS

10, 20 Piping elements/pipes
12 End face/sealing face
30 Safety area/housing
32 Check flap
34 Pivot axle
36 Arresting arm/arresting lever
40 Arresting element
   (36, 40 arresting device)

1. A safety arrangement for a fluid piping system with a check flap associated with the piping system, where said check flap enables a medium to flow in the piping in an unblocked direction from an area onto which flow occurs into an area off of which flow occurs and where in a blocking position said check flap counteracts flow in a blocked direction opposite to the unblocked direction by abutting a sealing face of the piping system, characterized in that in the rest position of the sealing face when there is no flow in the piping system, the check flap is at a distance from the sealing face and starting from the rest position only conies to abut the sealing face on the application of pressure in the blocked direction.

2. The safety arrangement according to claim 1, characterized in that the check flap can be pivoted about a pivot axle fixed relative to the piping system and preferably disposed in the upper part of a safety area of the piping system, in particular running in the horizontal direction, and starting from the pivot axle can extend downwards approximately in a vertical plane, at least in the rest position.

3. The safety arrangement according to claim 1, characterized in that the sealing face is formed by an end face of a piping element such as, for example, a pipe or tube of the piping system.

4. The safety arrangement according to claim 3, characterized in that the check flap is shaped to be complementary to the end face forming the sealing face, in the blocking position completely covers this end face, and in the rest position is disposed at a distance from the end face.

5. The safety arrangement according to claim 1, characterized in that the sealing face is disposed completely in a plane making an acute angle of preferably approximately 3 to 30° with a vertical plane.

6. The safety arrangement according to claim 1, characterized in that an arresting device is associated with a check flap, with which arresting device it can be arrested in the blocking position so that it also blocks flow in the piping in the unblocked direction.

7. The safety arrangement according to claim 6, characterized in that the arresting device comprises an arresting arm, said arresting arm extending outside of the safety area transversely, in particular approximately perpendicularly, to the pivot axle, said arresting arm together with the check flap being pivotable relative to the pivot axle, said arresting arm in an arresting position working together with an arresting element which is fixed relative to the piping, and said arresting arm preferably being rod shaped.

8. The safety arrangement according to claim 2, characterized in that the safety area is bounded by a housing.

9. The safety arrangement according to claim 8, characterized in that the arresting element is fastened on an outer bounding face of the housing.

10. A filter arrangement, in particular for dust-laden gases, with a safety arrangement according to any one of the preceding claims.
